(19) United States
(12) Patent Application Publication
(10) Pub. No.: US 2004/0076711 A1
(43) Pub. Date: Apr. 22, 2004

(54) Chewing gum

(76) Inventors: Jordi Margineda De Godos, Sant Cugat Del Valles (ES); Valiente Malmagro, Sant Cugat Del Valles (ES); Gonzalo Ruaix, Sabadell (ES)

Correspondence Address: STEINBERG & RASKIN, P.C., 1140 AVENUE OF THE AMERICAS, 15th FLOOR, NEW YORK, NY, 10036-5803, US

(21) Appl. No.: 10/451,311

(22) PCT Filed: Dec. 20, 2001
(86) PCT No.: PCT/IB01/02703

(30) Foreign Application Priority Data
Dec. 20, 2000 (ES) P200003137

(51) Int. Cl. A23G 3/30

(52) U.S. Cl. 426/3

(57) ABSTRACT

Comprises a base gum, a mixture of additives and at least one resin charged with Ca⁺², F⁻, PO₄⁻³ or Zn⁻² cations or anions, with the calcium, fluoride and phosphate being in a molar ratio of 2:1:1 and the zinc ions in a dry-weight proportion with respect to the resin of between 0.5 and 2%. It is used as a remineraliser of dental tissues, for the treatment of buccal infections or for obtaining a treatment against caries.

### FIELD OF THE INVENTION

This invention relates to a chewing gum which includes at least one encapsulated ion-exchange resin.

This invention also relates to the use of said chewing gum as a remineraliser of dental tissues.

### BACKGROUND OF THE INVENTION

This invention relates to a chewing gum with remineralising effect.

Known in the art are chewing gums which include a base gum and a mixture of additives. There exist numerous patents and publications which describe chewing gums containing compounds of calcium, such as calcium lactate (DE patent 2543489, 1976), calcium nitrate (WO patent 9706774, 1997); of fluoride (Santos de los, R. et al., Caries Res., 28(6):441-446 (1994), Wang, C. W., et al., Caries Res., 27(6):455-460 (1993), Lamb W. J. et al., Caries Res., 27(2):111-116 (1993), and sodium fluoride (WO patent 9706774, 1997); or of phosphate, such as potassium phosphates (WO patent 9706774, 1997, U.S. Pat. No. 5,958,380, 1999) and sodium phosphates (DE patent 2543489, 1976) as well as practically insoluble compounds of calcium and phosphate (WO patent 9807448, 1998) or of calcium, phosphate and fluoride (U.S. Pat. No. 5,460,803, 1995). But within the state of the art there is known no use of ion-exchange resins in chewing gums for the release of inorganic ions.

The base gums of the invention are those of known use in the manufacturing of chewing gum. In this invention the base gums used were the following:

Type I: chewing-type gum without paraffins.

Type II: bubble-type gum without paraffins.

Type III: bubble-type gum with paraffins (for bubble gums with sugar).

The chewing gum also comprises additives, which are the ones used in a typical chewing gum, as examples of which we might note the following mixtures (expressed in % by weight with respect to the total weight of chewing gum):

Mixture A: glycerine (7%), lecithin (0.3%) and sorbitol (57.7%).

Mixture B: glycerine (6.2%), lecithin (0.27%), sorbitol (51.4%), xylitol (5%) and glucose syrup (5.9%).

Mixture C: glycerine (7%), lecithin (0.3%), sorbitol (48.5%), xylitol (5%), glucose syrup (2%), powdered mint flavouring (1%), liquid mint flavouring (1%), aspartame (0.1%) and acesulphame-K (0.1%).

Mixture D: ground sugar (50%), glucose syrup (18.5%), glycerine (0.8%) and liquid tutti-frutti flavouring (0.7%).

Mixture E: powdered mint flavouring (1%) and liquid mint flavouring (1%).

### DESCRIPTION OF THE INVENTION

In this invention the effect of encapsulating resins, both monocomponent and polycomponent, was determined on the speed of release of ions in chewing gum matrices. A study was therefore made of the effect of the type of base gum on the various ion-releasing resins.

The chewing gum of the invention is characterised in that it comprises a base gum, a mixture of additives and at least one ion-exchange resin charged with cations or anions, whose ions are Ca⁺², F⁻, PO₄⁻³ or Zn⁻². When the calcium, fluoride and phosphate ions are present in the mixture of resins, they are preferably in a molar ratio of 2:1:1. Preferably, the Zn⁻² ions are in a dry-weight proportion of between 0.5-2%. Said resin or mixture of resins (denominated NMTD) includes:

Cationic resin of the weak acid or strong acid character charged with calcium ions (R—Ca).

Cationic resin of the weak acid or strong acid character charged with zinc ions (R—Zn).

Anionic resin of the weak base or strong base character charged with phosphate ions (R—F).

Anionic resin of the weak base or strong base character charged with fluoride ions (R—PO4).

In the present invention, the term “strong acid/base” is referred to an acid or a base that it is totally dissociated in an aqueous media.

In the same way, in the present invention, the term “weak acid/base” is referred to an acid or a base that it is partially dissociated in an aqueous media.

Moreover, it is preferable that the resin or mixture of resins is in a proportion by weight with respect to the base gum of between 5-20%.

Table 1 shows a summary of the prepared samples in which a mixture of resins is used with a composition the same as that of the NMTD (multicomponent).

TABLE 1
Samples prepared with a mixture of resins
the same as that of the NMTD

| | | | NMTD | NMTD |
|---|---|---|---|---|
| | | | concentration | concentration |
| Sample | Base gum | Additives | (% of total) | (% of base gum) |
| 1 | Type I | — | 5 | 5 |
| 2 | Type I | — | 15 | 15 |
| 3 | Type I | A | 5 | 16.7 |
| 4 | Type I | B | 5 | 16.7 |
| 5 | Type I | C | 5 | 16.7 |
| 6 | Type II | — | 5 | 5 |
| 7 | Type II | — | 15 | 15 |
| 8 | Type II | A | 5 | 16.7 |
| 9 | Type II | B | 5 | 16.7 |
| 10 | Type II | C | 5 | 16.7 |
| 11 | Type III | — | 5 | 5 |
| 12 | Type III | D | 5 | 20 |

Furthermore, samples were prepared using component resins which are summarised in Table 2.

TABLE 2
Samples prepared with a monocomponent resin

| | | | | Resin concentration |
|---|---|---|---|---|
| Sample | Base gum | Additives | Resin | (% of total) |
| 13 | Type II | — | R-Ca | 5 |
| 14 | Type II | E | R-Ca | 5 |
| 15 | Type II | — | R-F | 5 |
| 16 | Type II | E | R-F | 5 |

The speed of release of the ions of the prepared samples was compared with the speed of release of the non-encapsulated resins.

### Type I Base Gum

For samples 1 and 2 (without additives) it was observed that in the case of the calcium the speed of release was similar to that obtained with non-encapsulated MTD, although the final release obtained was greater in the encapsulated samples. In the case of fluoride release, a reduction in the speed of release was observed, although the quantity of ion released at longer time-periods was similar to that of the non-encapsulated NMTD. And, finally, for the phosphate ion the results were very similar both for the encapsulated and non-encapsulated MTD. The results were similar for the two concentrations of NMTD tested, although for an NMTD concentration of 15% the releases were slightly higher than when a 5% concentration of NMTD was used.

When additives were added (samples 3-5), a significant increase in the release of all the ions was observed, with no great differences obtained between the three samples in the case of the releases of calcium and fluoride. In the case of the phosphate, its release increased the more additives were added (release for sample 5 greater than for sample 4 and greater than sample 3). This observed increase in release of the ions may be due to the additives added being soluble, and when the sample is brought into contact with the solution the additives solubilise and assist breakdown of the solution and permit easier interaction between the NMTD and the solution, thereby favouring release of the ions.

These effects can be corrected by control of the ionic charge and of the nature of the resins used.

### Type II Base Gum

In this case, greater differences were observed for gums without additives with different concentrations of NMTD (samples 6 and 7). For a 5% NMTD content the speeds of release of calcium and fluoride were slightly slower than those obtained for the non-encapsulated NMTD, while the releases obtained with the phosphate ion were very similar. The releases obtained with the samples containing 15% of NMTD were higher than those obtained for samples with 5%, so that here releases similar to the non-encapsulated resins were obtained for the fluoride and calcium but higher in the case of the phosphate.

As in the case of the previous base gum, the addition of additives (samples 8-10) caused an increase in the speed of release of all the ions, and it was observed that for samples 8 and 9 that release was similar, while for sample 10 a much greater increase was observed, especially in the case of the phosphorus and calcium.

### Type III Base Gum

For this type of gum and where no additive was added (sample 11), only the speed of release of calcium was similar to the case of non-encapsulated NMTD. Significantly lower release speeds were obtained for the fluoride and phosphate ions.

For sample 12, which already contained various additives, the release speeds obtained were very much higher for calcium and phosphate and of the same order as in the case of non-encapsulated NMTD for the fluoride ion.

### Monocomponent Resin

In the case of the studies carried out using samples prepared with monocomponent resins charged with calcium or fluoride (samples 13 and 15), no variation in release of ions was observed with respect to the results obtained with those same monocomponent resins in non-encapsulated form.

The addition of flavourings to these samples (samples 14 and 16) did not cause any significant change in release of the ions.

In accordance with the results obtained, release of the remineralising ions following encapsulation is controlled, in both monocomponent and polycomponent resins. It is also observed that encapsulation of resins in base gum alters their release characteristics. This alteration depends on the type of base gum used and is different for each of the ions studied.

The addition of additives also alters the release properties of the resins, this alteration being different for each ion and depending on the nature of the additives.

Once the nature of the effects of the base gums and of the additives present in a chewing gum is known, it is possible to modify and control their behaviour with the objective of obtaining a suitable release speed. Control of said speed can be carried out by acting on the ion concentration in the resin or by using resins of a different nature (monocomponent or polycomponent).

The chewing gum described in this invention, which comprises at least one resin, can be used in remineralisation of dental tissues. Owing to this effect on the zone of the tooth in contact with the gum, this material is also beneficial in the preventive or symptomatic treatment of buccal infections such as caries.

The characteristics described above permit the use of chewing gums containing sugar with a lower risk of caries than is the case with conventional chewing gums, since the remineralising effect lasts for the entire time that the gum is in contact with the zone of the tooth, whereas the release of sugar takes place in the first few minutes of mastication.

### FIGS.

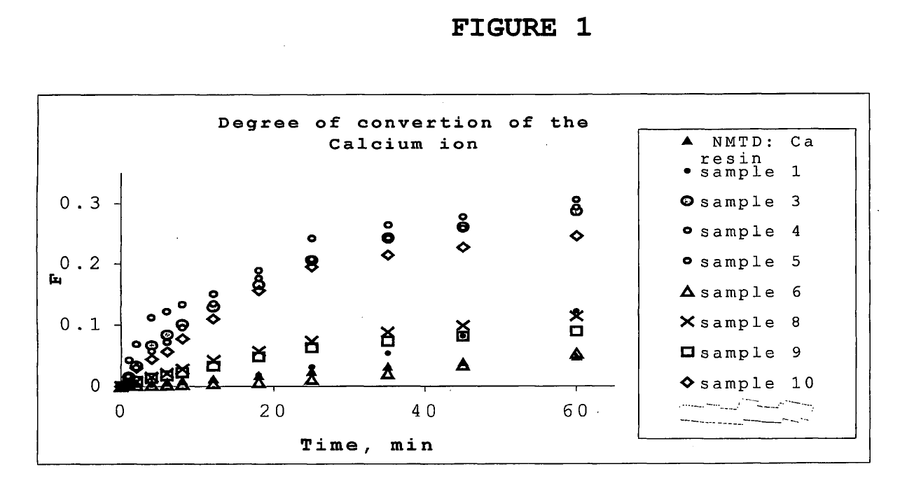

FIG. 1

The FIG. 1 attached shows the effect of the nature both of the encapsulating matrix and of the additives on release of the calcium ion for samples of chewing gum containing NMTD (samples 1, 3, 4 and 5 prepared with the type-I base gum and samples 6, 8, 9 and prepared with the type-II base gum) . The release of calcium obtained for these samples is compared with that obtained when the NMTD is not encapsulated (resin sample NMTD:Ca).

In the figure, the degree of conversion (F) is the quotient of the quantity of ion released and the quantity of ion present in the sample.

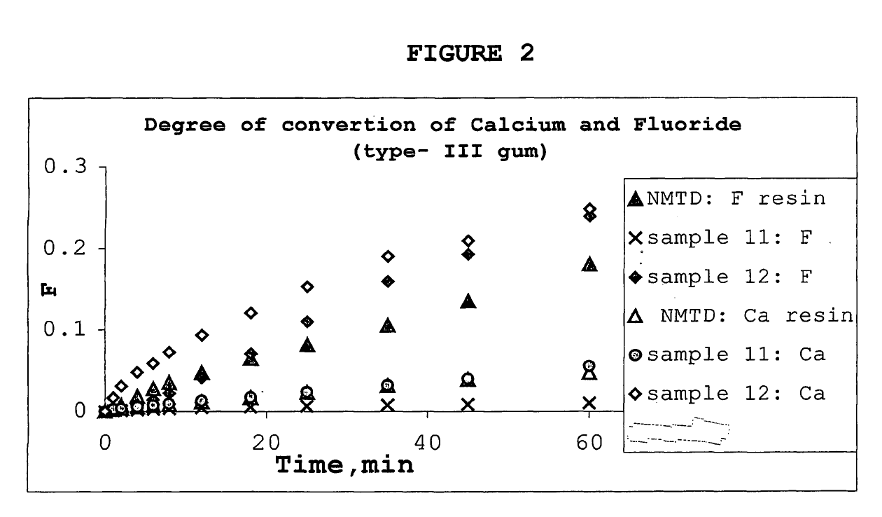

FIG. 2

The FIG. (2) shows the effect of an encapsulating matrix (type-III base gum) and of the same additives on the release of different ions (calcium and fluoride) for samples of chewing gum containing NMTD. The release obtained is compared with the release of calcium and fluorine in non-encapsulated samples of NMTD (samples of NMTD: Ca resin and NMTD: F resin, respectively).

The degree of conversion (F) has the same meaning as in the previous case.

1. Chewing gum, which comprises a base gum and a mixture of additives, characterised in that it comprises at least one resin charged with cations or anions, said resin or resins including the ions Ca⁺², F⁻, PO₄⁻³ or Zn⁺².

2. Chewing gum, as claimed in claim 1, in which the resin or resins comprise the ions Ca⁺², F⁻, PO₄⁻³ in a molar ratio of 2:1:1.

3. Chewing gum, as claimed in claim 1, where the mixture of resins includes:
Cationic resin of the weak acid or strong acid character charged with calcium ions (R—Ca).
Cationic resin of the weak acid or strong acid character charged with zinc ions (R—Zn).
Anionic resin of the weak base or strong base character charged with fluoride ions (R—F).
Anionic resin of the weak base or strong base character charged with phosphate ions (R—PO4).

4. Chewing gum, as claimed in claim 1, in which the mixture of resins is in a proportion by weight of between 5-20%.

5. Chewing gum, as claimed in claim 1, in which the Zn⁺² ion is in a dry-weight proportion with respect to the resin of between 0.5-2%.

6. Chewing gum, as claimed in any of the previous claims, for use thereof in the remineralisation of dental tissues.

7. Use of a chewing gum, as claimed in any of the previous claims, for the treatment of buccal infections.

8. Use of a chewing gum, as claimed in any of the previous claims, for the manufacturing of a medicine for the treatment of caries.
